(19) United States
(12) Patent Application Publication
(10) Pub. No.: US 2025/0274785 A1
(43) Pub. Date: Aug. 28, 2025

(54) MECHANISMS FOR ADDRESSING INACCURACIES IN BEAM PREDICTIONS

(71) Applicant: SHARP KABUSHIKI KAISHA, Sakai City (JP)

(72) Inventors: Rudraksh Shrivastava, Erligheim (DE); Tomoki Yoshimura, Camas, WA (US)

(21) Appl. No.: 18/586,463

(22) Filed: Feb. 24, 2024

(51) Int. Cl. H04W 24/04; H04W 24/08

(52) U.S. Cl. CPC H04W 24/04; H04W 24/08

(57) ABSTRACT

A user equipment (UE) that includes one or more non-transitory computer-readable media that stores computer-executable instructions for reporting failures in predictive beam configurations received from a base station (BS) and a processor is provided. The processor is configured to receive, from the BS, a configuration that configures the UE with several predicted transmission configuration indication (TCI) states divided into several subsets of predicted TCI states detect a first beam associated with a first reference signal resource. The processor is configured to determine the identification of a second predicted beam associated with a first predicted TCI state in a first subset of predicted TCI states that is associated with the first reference signal resource, determine that an identification of the detected first beam does not match the identification of the second predicted beam, and send a failure message indicating to the BS that the configuration is invalid.

### TECHNICAL FIELD

The technology generally relates to wireless communications, and more particularly, to predictive beam configuration.

### BACKGROUND

Because of the tremendous growth in the number of connected devices and the rapid increase in user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation radio communication systems.

### SUMMARY

In a first aspect of the present application, a user equipment (UE) is provided. The UE includes one or more non-transitory computer-readable media storing one or more computer-executable instructions for reporting failures in predictive beam configurations received from a base station (BS). The at least one processor is configured to execute the one or more computer-executable instructions to cause the UE to receive, from the BS, a first configuration that configures the UE with several predicted transmission configuration indication (TCI) states divided into several subsets of predicted TCI states, each subset associated with a different reference signal resources; detect a first beam associated with a first reference signal resource; determine the identification of a second predicted beam associated with a first predicted TCI state in a first subset of predicted TCI states that is associated with the first reference signal resource; determine that the identification of the detected first beam does not match the identification of the second predicted beam; and send a failure message indicating to the BS that the first configuration is invalid.

In an implementation of the first aspect, the failure message includes information of the detected first beam as a cause of failure.

In another implementation of the first aspect, the information includes a set of layer 1 reference signal reception power (L1-RSRP) measurements.

In another implementation of the first aspect, the information is for use by the BS to generate a second configuration, the at least one processor is further configured to execute the one or more computer-executable instructions to cause the UE to receive, from the BS, the second configuration that configures the UE with at least one TCI state that is not in the several TCI states.

In another implementation of the first aspect, the failure message includes information of the predicted second beam as a cause of failure.

In another implementation of the first aspect, the at least one processor is further configured to execute the one or more computer-executable instructions to cause the UE to perform a set of one or more beam failure recovery procedures with the BS.

In a second aspect of the present application, UE is provided. The UE includes one or more non-transitory computer-readable media storing one or more computer-executable instructions for reporting failures in predictive beam configurations received from a BS. The at least one processor is configured to execute the one or more computer-executable instructions to cause the UE to receive, from the BS, a first configuration that configures the UE with several predicted TCI states divided into several subsets of predicted TCI states, each subset associated with a different reference signal resource, each predicted TCI state associated with a set of one or more beam configuration parameters; detect a first beam associated with a first reference signal resource; determine the identification of a second predicted beam associated with a first predicted TCI state in a first subset of predicted TCI states that is associated with the first reference signal resource; detect a failure in a mapping to the set of beam configuration parameters associated with the first predicted TCI state; and send a failure message indicating to the BS that the first configuration is invalid.

In an implementation of the second aspect, detecting the failure in the mapping includes determining that at least one beam configuration parameter in the set of beam configuration parameters associated with the first predicted TCI state does not match with a corresponding beam configuration parameter associated with the detected first beam.

In another implementation of the second aspect, detecting the failure in the mapping includes determining that the UE is unable to map to the set of beam configuration parameters associated with the first predicted TCI state.

In another implementation of the second aspect, detecting the failure in the mapping includes determining that the UE takes more than a threshold amount of time to map to the set of beam configuration parameters associated with the first predicted TCI state.

In another implementation of the second aspect, the failure message is for use by the BS to generate a second configuration, the at least one processor is further configured to execute the one or more computer-executable instructions to cause the UE to receive, from the BS, the second configuration that configures the UE with at least one TCI state that is not in the several TCI states.

In another implementation of the second aspect, the one or more beam configuration parameters includes one or more of a predicted beam identification, serving cell information, beamforming weights, a beamwidth, beam directionality, a beam polarization setting, a channel resource index (CRI), RSRP related information, and a beam codebook.

In another implementation of the second aspect, the at least one processor is further configured to execute the one or more computer-executable instructions to cause the UE to receive a message from the BS deactivating a use of the first configuration by the UE to identify beams.

In another implementation of the second aspect, the at least one processor is further configured to execute the one or more computer-executable instructions to cause the UE to determine an accuracy of beam prediction is below a threshold; deactivate a use of the first configuration to identify beams; and send a message to the BS indicating the use of the first configuration is deactivated by the UE.

In a third aspect of the present application, a method of reporting failures in predictive beam configurations received from a BS is provided. The method includes receiving, from the BS, a first configuration that configures the UE with several predicted TCI states divided into several subsets of predicted TCI states, each subset associated with a different reference signal resources; detecting a first beam associated with a first reference signal resource; determining the identification of a second predicted beam associated with a first predicted TCI state in a first subset of predicted TCI states that is associated with the first reference signal resource; determining that the identification of the detected first beam does not match the identification of the second predicted beam; and sending a failure message indicating to the BS that the first configuration is invalid.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating beam management, according to an example implementation of the present disclosure.

FIG. 2 is a sequence diagram illustrating an example message flow for beam detection indication, according to prior art.

FIG. 3 is a sequence diagram illustrating an example message flow for beam management, according to an example implementation of the present disclosure.

FIG. 4 illustrates a table of the predicted TCI values and the predicted beams in future slots or TTIs, according to an example implementation of the present disclosure.

FIG. 5 illustrates a table of the predicted TCI range in future slots or TTIs, according to an example implementation of the present disclosure.

FIG. 6 illustrates a table of a single predicted TCI state or index associated with one or multiple beams in future slots or TTIs, according to an example implementation of the present disclosure.

FIG. 7 illustrates a table of multiple predicted TCI states or indexes associated with one or multiple beams in future slots or TTIs, according to an example implementation of the present disclosure.

FIG. 8 is a sequence diagram illustrating an example message flow for beam management in which the UE does not report the successful mapping of the beam ID to the predicted TCI state index, according to an example implementation of the present disclosure.

FIG. 9 is a flowchart illustrating an example method/process performed by a UE for receiving predictive beam configurations from a BS, according to an example implementation of the present disclosure.

FIG. 10 is a sequence diagram illustrating an example message flow for detection and reporting a mismatch between a detected beam and a predicted beam, according to an example implementation of the present disclosure.

FIG. 11 is a flowchart illustrating an example method/process performed by a UE for detecting and reporting a mismatch between a detected beam and a predicted beam, according to an example implementation of the present disclosure.

FIG. 12 is a sequence diagram illustrating an example message flow for detection and reporting a mapping failure after detecting a predicted map, according to an example implementation of the present disclosure.

FIG. 13 is a flowchart illustrating an example method/process performed by a UE for detecting and reporting a mapping failure in one or more beam configuration parameters, according to an example implementation of the present disclosure.

FIG. 14 is a flowchart illustrating an example process that describes the UE's behavior, including failure detection and reporting, after receiving the beam prediction configuration and beam configuration/management information from the network, according to an example implementation of the present disclosure.

FIG. 15 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A, and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in an RRC_CONNECTED state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present embodiment, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel is typically consisted of a plurality of antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActive UplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication”. The “DL only” and “UL only” may also be referred to as a “separate TCI state,” as opposed to the “joint TCI state”.

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected as the representative AI/ML sub-use cases. The first use case (BM-Case1) may be for spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the NW side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1 reference signal reception power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or reception (Rx) beam ID.

The second use case (BM-Case2) may be for temporal downlink beam prediction for Set A of beams based on the historic measurement results of Set B of beams. For the BM-Case2, the following alternatives may be considered. The AI/ML model training and inference may be done either at the NW side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the current implementation of the 3GPP, management of the beam prediction information, and configuration of the same to the UEs are not described. In addition, the UE and network behaviors are not specified in a case where the AI/ML beam prediction information is not accurate or does not match the actual beam measurements by the UE. Present disclosure provides mechanisms for the management and configuration of the (AI/ML) beam prediction information, as well as, for detection and reporting of inaccuracies in the (AI/ML) beam prediction information.

Several examples of the present embodiments are described using, for example, the Beam Management Case 2, as described above. In these embodiments, beam prediction using the AI/ML model may be performed at the UE side or at the network side using, for example, parameters like the actual or predicted L1-RSRP or using historic measurements of the beams, and/or any other AI/ML mechanisms. The present embodiments address the issues related to beam prediction information and related parameters, the application of beam prediction related parameters and its configuration procedure to the UE(s), the UE's behavior when an actual beam is detected and how it maps to the beam prediction configuration provided, in advance, by the network. The present embodiments address the failure scenarios by defining the UE's and network's behavior when the network configured beam prediction configuration is not accurate and does not match the actual beam measurements by the UE.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like KPI, the AI/ML model may provide output in the form of F(f1,f2 . . . fn) predictions for T(t1,t2, . . . tn) future time instances. The prediction may reflect predicted beams and their corresponding configurations.

### Beam Pair Selection Process

There may be three distinct DL processes of operations to obtain the best beam pair selection. These processes are colloquially referred to as P1, P2 and P3 in technical discussions and reports.

P1 is the initial process dedicated to the BS (e.g., gNB) beam selection. In P1, broad beams are typically used to sweep the angular space and a coarse serving direction may be chosen based on measurements from a broad-beam UE. P1 may be used to enable the UE measurement on different TRP Tx beams to support selection of the TRP Tx beams/UE Rx beam(s). Beamforming at the TRP, may typically include an intra/inter-TRP Tx beam sweep from a set of different beams. Beamforming at the UE may typically include a UE Rx beam sweep from a set of different beams. Before a data flow is enabled in the scheduler, periodic SSB beam scanning may be implemented on the BS side in a certain intervals (the SSB periodicity). At the same time, wide beam scanning may be implemented on the UE side to determine the optimal receive wide beam (the Optimal SSB/Physical Random Access Channel (SSB/PRACH) beams).

P2 is the second process to refine P1's beam selection using narrower BS beams. P2 may still employ a broad beam at the UE. P2 may be used to enable the UE measurements on different TRP Tx beams to possibly change the inter/intra-TRP Tx beam(s). P2 may use a possibly smaller set of beams for beam refinement than P1. It should be noted that that P2 may be a special case of P1, for example, by performing a beam sweep in a narrower angular sector than in P1. The narrow beams closest to the wide beam in the beam grid may be selected to be examined using CSI-RS (followed by CSI-report).

P3 is the final process of beam alignment for the UEs equipped to support beamforming. After beam selection at the BS side, the transmit beam may be fixed so the UE may refine its broad beam by sweeping through its own narrow beams. P3 may be used to enable the UE measurements on the same TRP Tx beam to change the UE Rx beam in the case the UE uses beamforming.

The optimal narrow beam may be selected from P2, and the CSI-RSs may be transmitted to the UE. The UE may update its Rx beam. In the data transmission, the BS may use the best BS Tx beam found during P2 and the UE may use the best UE Rx beam found during P3.

It should be noted that, while data transmission is being performed on an active beam pair link, the UE may monitor the PDCCH on another beam pair as a backup link for swift fallback if there is a sudden blockage of the active link.

### Synchronization Signal Blocks

The Synchronization Signal/Physical Broadcast Channel (SS/PBCH) Blocks, typically shortened to SSBs, are a pivotal part of the NR. The SSBs may be broadcast periodically for the UE's measurement purposes. A single SSB, spanning 4 OFDM symbols in time and 240 subcarriers in frequency, may include both synchronization signals and broadcast channels. The Primary Synchronization Signal (PSS) and the Secondary Synchronization Signal (SSS) may be carried in the SSB as two 127-long pseudo random binary m-sequences employed for initial synchronization and cell identification. The PBCH associated with the Demodulation Reference Signal (DMRS) may contain system control information that the UE may require to communicate with the network.

During the beam sweeping procedure, the SSBs may be transmitted in groups, known as SSBursts, according to a numerology-dependent transmission pattern. In Frequency Range 2 (FR2), an SSBurst may contain up to 64 SSBs. Each SSB may be mapped to a unique BS beam so that the UE may decode it, measure that beam's power level, and report the beam's L1-RSRP value back to the BS for beam determination. This may be done through SS-RSRP, which may be defined as the linear average over the power contributions in Watt of the resource elements that carry an SSS. For beam acquisition, SSBs are usually employed during P1, where broader beams are considered.

The CSI-RSs are UE-specific signals transmitted by the BS to monitor the DL radio channel conditions. These NR signals are extremely flexible, allowing for 18 different time-frequency allocation configurations tailored to a multitude of applications, such as, Channel State Information (CSI) acquisition, radio resource management (RRM), or beam management. For beam management, the CSI-RS may only be configured through three distinct configurations to be used, similarly to SSBs, in L1-RSRP measurements for beam candidate selection. This may be achieved using the CSI-RSRP, which is the linear average over the power contributions in Watt of the resource elements of the antenna port(s) that carry CSI-RS configured for RSRP measurements within the considered measurement frequency bandwidth in the configured CSI-RS occasions.

In the context of beam acquisition, the CSI-RSs are associated with narrower beams and, therefore, are employed in both P2 and P3, as described above. However, their configurations differ in a higher layer parameter named “repetition,” which displays a binary “on” or “off” state. The repetition parameter may only be set for the CSI-RSs that are configured for the L1-RSRP and it may let the UE make a determination regarding the DL beamforming configuration on the BS side. In P2, the repetition parameter may be set to “off,” entailing that the beamforming applied to each CSI-RS resource at the BS may vary. Therefore, the UE may take that information as an indication to maintain the same spatial filtering until P2 is complete. In P3, however, the repetition parameter may be set to “on,” which means that the UE may assume that no beam sweeping is performed on the BS side and, therefore, the UE is free to sweep through its own beams for the purpose of beam refinement.

### Beam Management

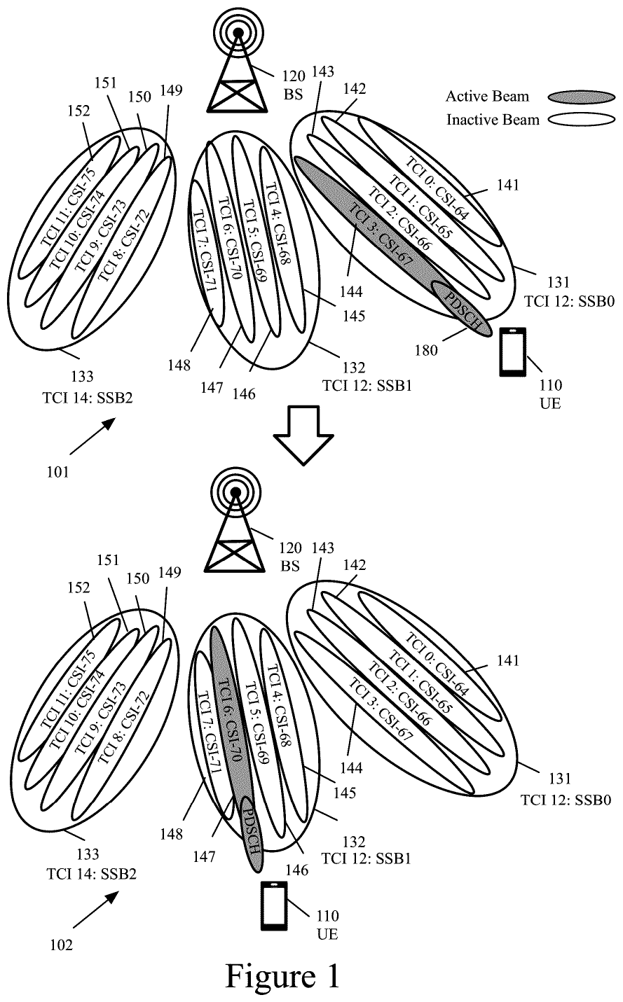

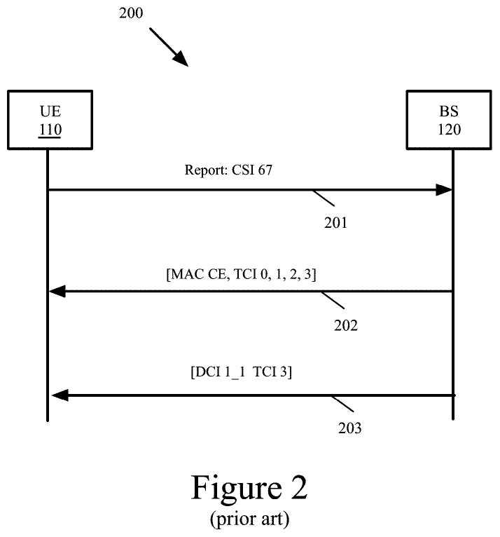

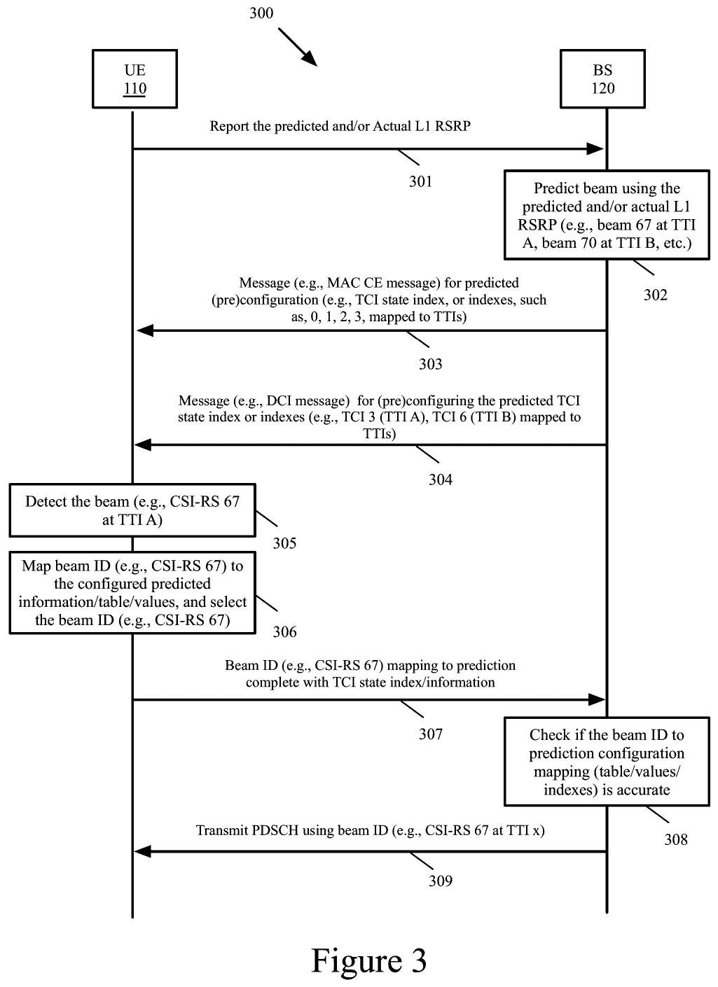

FIG. 1 is a schematic diagram illustrating beam management, according to an example implementation of the present disclosure. In the example of FIG. 1, the BS 120 may have already (pre) configured the UE 110 with the predicted TCI states, as a list, as a single parameter, or as a table/matrix, which may be collocated with associated SSBs (e.g. 0, 1, 2, etc.). The term (pre) configuration indicates that, in the beam management of the present embodiments, the BS may provide the TCI state for a beam to the UE either prior to the beam is detected by the UE or after a beam is detected by the UE. In addition, in the beam management of the present embodiments, the BS may provide the TCI states for several future beams to the UE. In contrast, the prior art beam management, as described below with reference to FIG. 2, provide the TCI state for beam, only after the UE detects and reports the beam detection to the BS, Further details of the (pre) configuration of the UE with the predicted TCI states are described below with reference to FIGS. 3-14.

As shown, the UE may be (pre) configured such that, for several slots (or TTIs) in future, the UE is predicted to detect different channels that are identified by their corresponding CSI-RSs. The (pre) configuration may enable the UE to determine the TCI state at which the UE may receive DL data (e.g., the PDSCH) after the UE detects the corresponding channel. For example, in a case that the UE detects beam 141 (the beam associated with the CSI-RS 64), the UE may receive DL data at TCI 0. The terms TCI n and TCI state index n, where n is an integer, are used interchangeably to maintain clarity.

In the example of FIG. 1, the (pre) configuration identifies three wide beams 131-133 and twelve narrow beams 141-152. The narrow beams 141-152 may be associated with the CSI-RSs 64-75, respectively. For each narrow beam 141 to 152, the UE may be (pre) configured to receive the DL data at a corresponding TCI state 0 to 11. Each narrow beam 141 to 152 may correspond to a different slot. Each wide beam 131-133 may be associated with a corresponding unique reference resource signal, such as SSB0-SSB3, and/or a unique TTI. For each wide beam 131, 132, and 133, the UE may receive the DL data at a (pre) configured TCI state 12, 12, and 14.

FIG. 1, as shown, includes two operational steps 101 and 102. Step 101 may occur at a first TTI, such as TTI A, and step 102 may occur at a second TTI, such as TTI B. In step 101, the UE has detected the beam 144 (the beam with the beam ID CSI-RS 67) at TTI A. For example, prior to detecting the beam 144, the UE may first scan the slot where the narrow beam 141 (the beam with the beam ID CSI-RS 64) is configured. The UE may detect the SSB0 (the wide beam 131), but the UE 110 may not detect the narrow beam 141 (e.g., the UE and the narrow beam 141 are not in line of sight with each other and/or the UE is not receiving a reflection of the narrow beam 141).

Similarly, at the slot where the narrow beam 142 (the beam with the beam ID CSI-RS 65) is configured, the UE 110 may detect the SSB0 (the wide beam 131), but the UE 110 may not detect the narrow beam 142 (e.g., the UE and the narrow beam 142 are not in line of sight with each other and/or the UE is not receiving a reflection of the narrow beam 142). At the slot where the beam 143 (the beam with the beam ID CSI-RS 66) is configured, UE 110 may detect the SSB0 (the wide beam 131), but the UE 110 may not detect the narrow beam 143 (the narrow beam with the beam ID CSI-RS 66), for example, the UE 110 and the beam 143 are not in line of sight with each other and/or the UE is not receiving a reflection of the narrow beam 143. However, the UE may scan the slot where the beam 144 (the beam with the beam ID CSI-RS 67) is configured and may detect the SSB0 (the wide beam 131). The UE 110 may also detect the narrow beam 144 since the UE and the narrow beam 144 are in line of sight with each other and/or the UE is receiving a reflection of the narrow beam 144.

In step 101, the UE 110 may verify that the UE is (pre) configured to detect beam 144 at TTI A. If the UE is not (pre) configured with the predictive beam configuration (e.g., to detect predictive beam 144), the UE may report its beam detection to the BS 120, and then receive the predictive configuration from the BS 120. Beam prediction (or logical beams assignment), which may occur at the UE side, or at the BS side, and communicating the predicted (or logical) beams with the other side, are described in great detail below.

If, on the other hand, the UE is (pre) configured to detect beam 144 at TTI A, using the beam prediction (pre) configuration information, the UE 110 may further determine that the UE 110 may receive DL data through the beam 144 at TCI state index 3. The UE 110 may then map to the TCI state index 3. For example, the UE 110 may set up different resources based on parameters associated with the TCI state index 3. In a case that the mapping is successful, the UE 110 may receive the DL data (e.g., the PDSCH 180) through beam 144. In step 101, the UE receives the PDSCH 180 without informing the BS 120 that the UE has detected beam 144. As such, the beam management of the present embodiments provide the technical advantage of reducing the signal overhead of reporting the beam detection to the BS 120 and receiving the TCI state from the BS after each beam detection.

In step 102, the UE may have moved to a different region and/or a different time slot. As such, the UE has detected the beam 147 (the beam associated with the CSI-RS 70) at TTI B. The UE 110 may verify that the UE is (pre) configured to detect the beam 147 at TTI B. Using the (pre) configuration information, the UE 110 may further determine that the UE 110 may receive DL data through the beam 147 at TCI 6 state.

The UE 110 may then map to the TCI 6. For example, the UE 110 may set up different resources based on parameters associated with the TCI 6. In a case that the mapping is successful, the UE 110 may receive the DL data (e.g., the PDSCH 180) through beam 147. In step 102, the UE receives the PDSCH 180 without informing the BS 120 that the UE has detected beam 147.

FIG. 2 is a sequence diagram 200 illustrating an example message flow for beam detection indication, according to prior art. In step 201, the UE 110 may scan a slot and may detect a beam, such as the beam associated with the CSI-RS 67. For example, the UE 110 may detect the beam 144 of FIG. 1. A few slots later, the UE 110 may report (as shown in step 201) the CSI-RS 67 to the BS 120, as shown in step 201 of FIG. 2.

After receiving the report that the UE 110 has detected the beam associated with the CSI-RS 67, the BS may send (as shown in step 202) a MAC CE message with the list of TCI states that are co-located with the SSB0 (e.g., the TCI 0, TCI 1, TCI 2, and TCI 3). The BS 120 may then send (at step 203) the DCI 1_1 with the TCI state index that is pointing to the CSI-RS 67 (e.g., the TCI 3 state). It should be noted that the TCI state index may be considered as an identifier of the TCI state, which is pointing to the TCI state. The BS 120 may then transmit the PDSCH using TCI 3 state configuration.

As shown in step 201 of FIG. 2, the prior art beam management procedures require the UE 110 to send a report to the BS 120 whenever a new beam is detected (and then receives the beam configuration for the corresponding beam from the BS in order to be able to receive DL data). In contrast, as described with reference to FIGS. 1 and 3, the beam management implementations of the present disclosure are not required to send any report to the BS 120 whenever a new beam is detected (or to receive the beam configuration from the BS for receiving DL data through the detected beam). The BS 120 may then send (as shown in step 203) the TCI state that corresponds to the detected beam to the UE 110.

With reference to FIGS. 1 and 2, the present embodiments provide the technical advantage of reducing the signal overhead for beam management. In the prior art, each time a UE detects a beam, the UE transmits the information regarding the detected beam, and the BS sends the TCI state only for the presently detected beam. In the present embodiments, the UE 110 may detect a first beam that is associated with a first reference signal resource (e.g., SSB0). The UE 110 may then transmit the information of the first beam and the first reference signal resource (e.g., the UE may transmit measured L1-RSRP, the CSI-RS of the detected beam, and/or SSB0) to the BS. The UE may than receive a configuration from the BS that configures the UE with TCI for multiple future beams. For example, the BS may send a first TCI state for receiving DL data through the first beam and a second TCI state for receiving DL data through one or more other future beams (e.g., a second beam associated with a second reference signal resource that is different form the first reference signal resource).

FIG. 3 is a sequence diagram 300 illustrating an example message flow for beam management, according to an example implementation of the present disclosure. In the example of FIG. 3, the AI/ML model training and inference is described to occur at the UE said, however, the same AI/ML techniques may be performed at the NW side to predict the logical beams.

At step 301, the UE 110 may report the predicted L1 RSRP (using e.g., the UE-side AI/ML model) and/or the actual L1 RSRP to the network. Based on the predicted L1 RSRP and/or the actual L1 RSRP reported by the UE 110, the network side AI/ML model may predict (as shown by the block 302) the beams (including the associated TCI states) in upcoming/future slots and/or the upcoming TTIs. For example, the network may predict beam 67 shown in FIG. 1 in a future slot A (TCI 3), beam 70 in a future slot B (TCI 6), beam 74 in a future slot C (TCI 10), etc.

In the embodiments that the beam prediction is done by the UE, the UE may predict the beam for future slots and may report the prediction to the BS 120 in step 301. The BS 120 may then associate the predicted beams with TCIs in block 302.

The BS 120 may indicate or (pre) configure (as shown by step 303) the UE 110 with predicted TCI state as a list, as a single parameter, or as a table/matrix (collocated with the associated SSB, e.g., 0, 1, 2, etc.). The BS 120 may (pre) configure the UE by using, for example, a new or enhanced message, such as, a new/enhanced MAC CE. It should be noted that term enhanced refers to modification to the existing 3GPP message structure to carry additional information related, e.g., to the TCI state(s) of the predicted beam (e.g., by adding additional fields). Other L1/L2/L3 messages, an activation command that is similar to MAC CE, an RRC, or any higher layer messages may also be used to transmit this information (or configuration) to the UE. The (pre) configuration may also include the predicted slot numbers and/or TTIs.

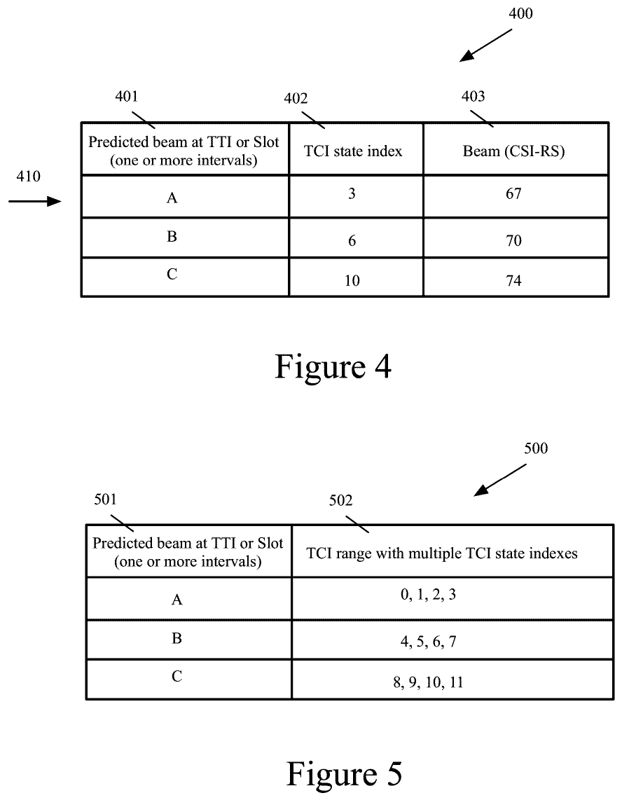

Examples of the (pre) configuration parameters are described with reference to the tables shown in FIGS. 4-7. The slots (or TTIs) A, B, C used in the examples of FIGS. 4-7 may include individual value(s), a range of values (e.g., multiple values), a range of slots (e.g., multiple time slots), or time values (e.g., one or more time instances). Different options and combinations are discussed below with reference to FIGS. 4-7.

FIG. 4 illustrates a table 400 of the predicted TCI state indexes 402 and the predicted beams 403 in future slots or TTIs 401, according to an example implementation of the present disclosure. The information in table 400 may be configured into the UE (e.g., as shown in step 303 of FIG. 3) using any L1/L2/L3 message, such as, MAC, DCI, or a higher layer messages. For example, a single predicted TCI state or index may be provided in a MAC CE message from the network.

If the network (pre) configures the UE 110 using a new message (e.g., an enhanced MAC CE) that provides only a single predicted TCI state for a given beam ID (e.g., TCI state index 3 for the CSI-RS 67), the UE 110 may choose that TCI state/index for the communication with the network. In this case, explicit predictive beam indication (pre) configuration by a command (e.g., a command similar to a DCI message) is not necessary because there is only one TCI state provided for a given beam ID, which may automatically be chosen by the UE. For example, as shown in the row 410 of table 400, if the UE determines that a CSI-RS (e.g., the CSI-RS 67) is associated with a TCI (e.g., TCI state index 3), then the UE may map the beam ID CSI-RS 67 to TCI state index 3 and may be ready to receive the PDSCH from the BS using TCI state index 3.

FIG. 5 illustrates a table 500 of the predicted TCI range 502 in future slots or TTIs 501, according to an example implementation of the present disclosure. The information in table 500 may be configured into the UE (e.g., as shown in step 303 of FIG. 3) using a configuration message, such as, MAC CE, RRC, any L1/L2/L3 message, or a higher layer messages. For example, multiple predicted TCI state or indexes may be provided in a message, such as MAC CE message, from the network.

The network may provide a beam prediction (pre) configuration to the UE 110 with multiple predicted TCI states or indexes (e.g., in a new or enhanced MAC CE message). In this scenario, the UE 110 may detect a beam (e.g., CSI-RS 67 at TTI A). The UE may then map the beam to the TCI group or range as provided in the predicted configuration by the network. The UE may then select one of the provided TCI states that best matches the detected beam ID for communication. For example, the UE may determine that a detected beam with CSI-RS 67 ID is associated with the TCI group/range 0,1,2,3) as shown in table 500. In this scenario, a message similar to a DCI message may be used by the BS 120 (as shown in step 304 of FIG. 3) to pre-configure the UE to select a single predicted TCI state (e.g., mapping to a detected beam, such as, CSI-RS 67). This single predicted TCI state may be selected out of the several TCI state/indexes provided within the TCI group/range. The UE may then select, for example, TCI state index 3 that is associated with CSI-RS 67 to receive the DL beam (e.g., the PDSCH) from the network.

As shown in step 304 of FIG. 3, the BS 120 may (pre) configure the UE 110 (by using a message, such as, an enhanced DCI) with a table or matrix, or a single value, that maps the predicted slots (e.g., TCI state index 3) with the TCI state index that points to the corresponding CSI-RS beam (e.g., CSI-RS 67) in slot A. Other L1/L2/L3 messages, MAC, RRC, or any higher layer message may also be used to transmit this information.

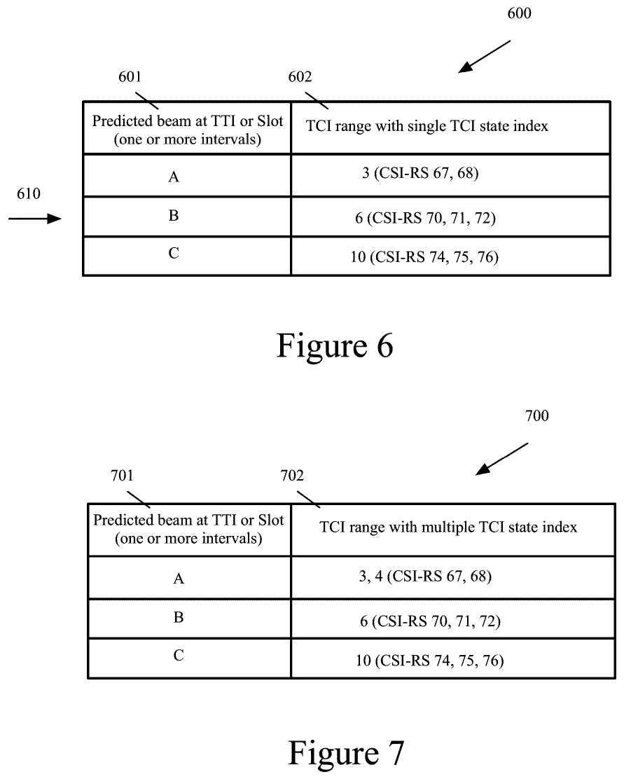

FIG. 6 illustrates a table 600 of a single predicted TCI state or index associated with one or multiple beams 602 in future slots or TTIs 601, according to an example implementation of the present disclosure. As shown in column 602 of FIG. 600, one or several beam IDs may be mapped or associated with a single TCI state index/TCI state or range (multiple TCI state indexes), providing a group of beams/CSI-RS associated with one or more TCI state indexes. The beam IDs (e.g., the CSI-RS) may be indicated in descending or ascending or any random order of priority for the UE to detect and map.

As an example, if at TTI B, the UE detects either one of the beams in the beam group (70,71,72), the UE is ready to receive PDSCH using TCI 6 as indicated in row 610 of table 600. The UE may not send beam prediction failure notification even if the best beam is not matching the AI/ML based prediction configuration provided by the network. If the detected beam is one of the beams within a beam group, it may be acceptable to the UE. The UE may transmit the prediction failure notification message if the detected beam is outside or not matching any of the beam IDs/group of the beam IDs configured by the network. For example, if the beam ID is 78 and is not included in the prediction configuration provided by the network for a given TTI and TCI value or range, the UE may send a beam prediction failure notification to the network. The beam IDs (e.g. the CSI-RSs) may be indicated in descending or ascending or any random order of priority for the UE to detect and map to the respective TCI index (or indexes).

FIG. 7 illustrates a table 700 of multiple predicted TCI states or indexes 702 associated with one or multiple beams in future slots or TTIs 701, according to an example implementation of the present disclosure. In the example of FIG. 7, each beam ID (as shown in column 702) may also be mapped or associated with one or more TCI state indexes/TCI states, providing a group of beams/CSI-RS. The beam IDs (e.g. the CSI-RSs) may be indicated in descending or ascending or any random order of priority for the UE to detect and map.

As an example, if at TTI B, the UE detects either one of the beams among the beam 70-72, the UE is ready to receive PDSCH using, for example, TCI 7 or 6. In this case, the UE may not send beam prediction failure notification because the detected beam(s) is/are in the TCI range. If the detected beam is one of the beams within the beam range, it may be acceptable to the UE. The UE may transmit the prediction failure notification message if the detected beam is outside or not matching the beam IDs configured by the network. For example, if the beam ID is 78 and is not included in the TCI range provided by the network for a given TTI and TCI value or range, the UE may send a beam prediction failure notification to the network.

Referring back to step 305 of FIG. 3, at a future time, the UE may scan the slot where CSI-RS 67 is configured. The UE may detect SSB0 (the wide beam). The UE may also detect (as shown in block 305), for example, the CSI-RS 67 (the narrow beam) at TTI A since the UE and the beam are in line with each other. In this case, instead of reporting the CSI-RS 67 to the network, to reduce the signaling overhead, the UE may check its (pre) configured prediction information table/configuration (e.g., configured by the BS).

In this case, if the UE determines, for example, that beam CSI-RS 67 is associated with TCI state index 3, the UE may map (as shown in step 306) the beam ID (e.g., CSI-RS 67) to the corresponding TCI state index (or indexes) as shown in table 500 of FIG. 5. Once the mapping is done, the UE 110 is ready to receive PDSCH using beam 67 from the BS 120.

If the UE does not know whether the beam CSI-RS 67 is associated with TCI state index 3, if the prediction information/configuration (configured or provided by the network/BS) of the current TTI or slot is available, the UE may map the TTI/slot with the corresponding TCI range as shown in table 500 (shown in FIG. 5). The UE may then map the TCI range index(es), or value(s), with the corresponding prediction table (e.g., as provided in a message similar to a DC message that provides the prediction parameters and configuration) or value as shown in table 400. This is like the two-step procedure of beam selection where MAC CE message activates the TCI state index(es), and the DCI message activates a TCI state index provided by the MAC CE message. In this way, the UE may know which TCI state index to use to receive the DL data (e.g., PDSCH). However, the UE may be (pre) configured by the network (using, e.g., messages, such as MAC and DCI messages) to first select the TCI state indexes range and then the specific index, as described above with reference to table 500 and 400 respectively.

As an example, consider the following. If the UE detects CSI-RS 67 at TTI A, the UE may map TTI A to the TCI range (0,1,2,3) as per table 500. Then the UE may map TTI A to TCI state index 3 using table 400. The UE may then be ready to receive at beam 67. In the embodiment of FIG. 3, the UE110 may send (as shown in step 307) a notification to the BS 120 that the mapping of the TCI to the beam ID CSI-RS 67 is successful according to the prediction information/table configured earlier by the network. This notification may also include the TCI state index and/or the TCI related information (as shown in step 307 FIG. 3). After receiving this notification, the BS 120 may verify (as shown in block 308) whether the UE's detected beam and the mapping to the predicted TCI and beam is accurate. After this is confirmed by the BS 120, the BS 120 may transmit PDSCH (as shown in step 309) using beam 67 at a future TTI x.

The DCI or a similar message, if required, may be used to configure the UE to select the corresponding TCI state index either in a pre-configured manner (e.g., the network may configure it in advance) or the network may send the TCI state index in real time like in the legacy procedure or it may be scheduled by the network.

In the existing 3GPP specifications, the MAC CE may include up to 8 TCI states. Therefore, in a new or enhanced MAC CE message of the present embodiments, a hybrid message may be used, where some of the elements/fields in the MAC CE may indicate actual/conventional TCI states while some may indicate predicted TCI states. The ratio between actual/existing and predicted TCI states may be up to UE or network implementation. Alternatively, a separate or a new message carrying only predicted TCI states including related beam configuration information may also be used.

In the examples discussed above, the UE may use tables 400, 500, 600, and 700 to adapt and map the network provided (pre) configuration to the detected beam(s). This may depend on whether the network has configured an individual value, a range of values (multiple values) of TCI state indexes, detected beams, etc., or a range of slots (multiple time slots) or time values (one or more time slots).

The AI/ML beam prediction and configuration may include, but not limited to, information and parameters, such as, TCI state values and indexes (predicted), the predicted beam ID (e.g., a logical beam ID for the predicted beam), serving cell information, beamforming weights, beamwidth, the beam directionality, and the beam polarization settings, the channel resource index (CRI), the RSRP related information, the beam codebook and related parameters, the reference signal index, etc.

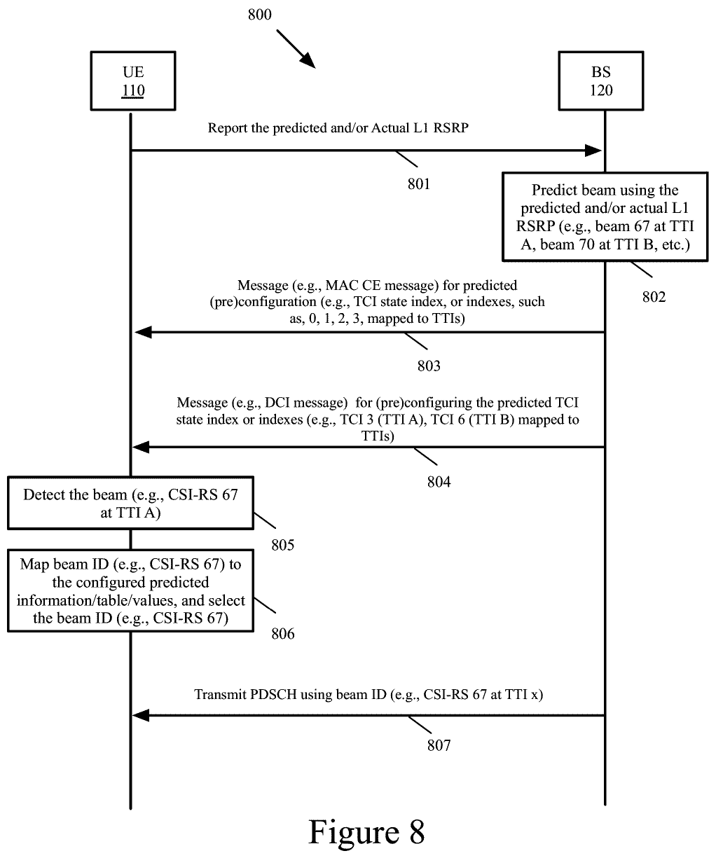

FIG. 8 is a sequence diagram 800 illustrating an example message flow for beam management in which the UE does not report the successful mapping of the beam ID to the predicted TCI state index, according to an example implementation of the present disclosure. In the example of FIG. 8, the steps (or blocks) 801-806 are similar to the corresponding steps (or blocks) 301-306 described above with reference to FIG. 3.

After step 806, instead of transmitting an indication regarding the successful mapping of the prediction information to the UE's actual measurements from the UE to the network (as in step 307 shown in FIG. 3), the UE may be prepared to receive the DL PDSCH based on the beam prediction (pre) configuration provided by the network. The UE 110 may wait for the BS 120 to send the PDSCH, for example, at TTI A or at a future TTI (TTI A+X), where A is the actual TTI and X is a certain delay at which the BS may transmit the PDSCH at the predicted CSI-RS beam (e.g., the beam with CSI-RS ID 67). It is assumed that both the BS and the UE are in sync and know the beam prediction (pre) configuration. Therefore, based on the prediction values, the BS may be aware of the beam detected by the UE at a specific TTI and the corresponding TCI state or index. Thus, the BS may transmit the DL PDSCH using the predicted beam configuration.

In another embodiment, the UE may report the beam ID (e.g., CSI-RS 67) to the BS as soon as the UE detects the beam. For example, the UE may report the detected beam in step 505 of FIG. 3. The BS knows that the related CSI-RS 67 prediction configuration/information is (pre) configured to the UE by the network based on the AI/ML model predictions. Therefore, the BS may transmit the PDSCH using beam 67 to the UE. For example, the BS may transmit the PDSCH at TTI A or TTI (A+x), where A is the actual TTI and x is a certain delay at which the BS transmits the PDSCH at the predicted CSI-RS beam (e.g., the CSI-RS 67 beam).

In another embodiment, the prediction configuration may be configured by the BS to the UE using signaling messages such as an enhanced MAC CE and an enhanced DCI together with the actual beam configuration/information with some enhancements or adding or extending fields to the existing beam management signaling framework.

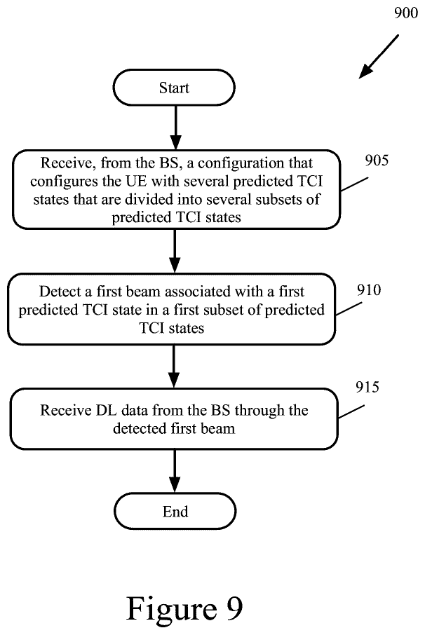

FIG. 9 is a flowchart illustrating an example method/process 900 performed by a UE for receiving predictive beam configurations from a BS, according to an example implementation of the present disclosure. With reference to FIG. 9, the process 900 may be performed by at least one processor of the UE 110, shown in FIGS. 1, 3, and 8.

The process 900 may receive (at block 905), from the BS, a configuration that configures the UE with several predicted TCI states that are divided into several subsets of predicted TCI states. For example, the process 900 may receive the configuration in a message, such as, MAC CE, DCI, RRC, etc.

The configuration may be received from the BS, for example, as described with reference to steps 303-304 in FIG. 3 or steps 803-804 in FIG. 8. As shown in FIG. 1, the UE 110 may receive a configuration that includes the predicted TCI states TCI 0 to TCI 11. The predicted TCI states TCI 0 to TCI 11 are divided into several subsets of predicted TCI states such as the subset that includes TCI 0 to TCI 3, the subset that includes TCI 4 to TCI 7, and the subset that includes TCI 8 to TCI 11.

Each subset 131-133 may be associated with a different reference signal resource. For example, the subsets 131, 132, and 133 in the example of FIG. 1 are associated with SSB0, SSB1, and SSB2, respectively. Other types of channel reference resources to which the subsets of predicted TCI states may be associated are CSI-RS, SRS, DMRS and PTRS. Each subset of the predicted TCI states 131-133 may be associated to a wide beam 131-133, and each predicted TCI state TCI 0 to TCI 11 may be associated with a narrow beam 141-152.

In the embodiments that the AI/ML prediction is performed by the BS, the UE may make several RSRP measurements over a period of time. The UE may also predict future RSRPs. The UE may send the predicted RSRPs and/or the measured or actual RSRP measurements to the BS prior to receiving the configuration from the BS (e.g., as shown in step 301 of FIG. 1). The BS may use the predicted RSRPs and/or the RSRP measurements to determine the predicted TCI states.

In the embodiments that the AI/ML prediction is performed by the UE, the UE may predict the beam for future slots and may report the prediction to the BS. The BS may then associate the beams predicted by the UE with TCIs.

Referring back to FIG. 9, the process 900 may detect (at block 910) a first beam associated with a first predicted TCI state in a first subset of predicted TCI states. For example, the UE 110 in FIG. 1 may detect the beam 144 that is associated with the subset of predicted TCI states that includes TCI 0 to TCI 3. The UE may detect a beam that may be a predicted beam.

The term predicted TCI states refers to the TCI states associated/assigned with the predicted beam in future time instances. Since the predicted beam is not an actual or measured beam yet, the predicted beam may be a considered as a logical beam. After the UE detects a beam that was predicted, the TCI state is assigned to the predicted beam and, therefore, it may be referred to as the predicted TCI state.

It should be noted that the process 900 receives the predicted TCI states prior to detecting the beam. In contrast, in the prior art beam management process shown in FIG. 2, the UE has to send a report regarding the detected beam to the BS. After receiving the report, the BS send the TCI subset associated to the wide beam and the TCI associated with the narrow beam to the UE. The beam management of the present embodiments provides the technical advantage of reducing the signal overhead for beam management.

The process may receive (at block 915) DL data from the BS through the detected first beam. For example, the UE 110 in FIG. 1 may receive the PDSCH 180 through the beam 144. The process 900 may then end.

### Failure Detection and Reporting

In some embodiments, the UE may detect a mismatch between a detected beam and a predicted beam. The UE may also detect a predicted beam and may detect a failure when mapping to the predicted beam configuration. The UE may report the beam mismatch or the mapping failure to the BS.

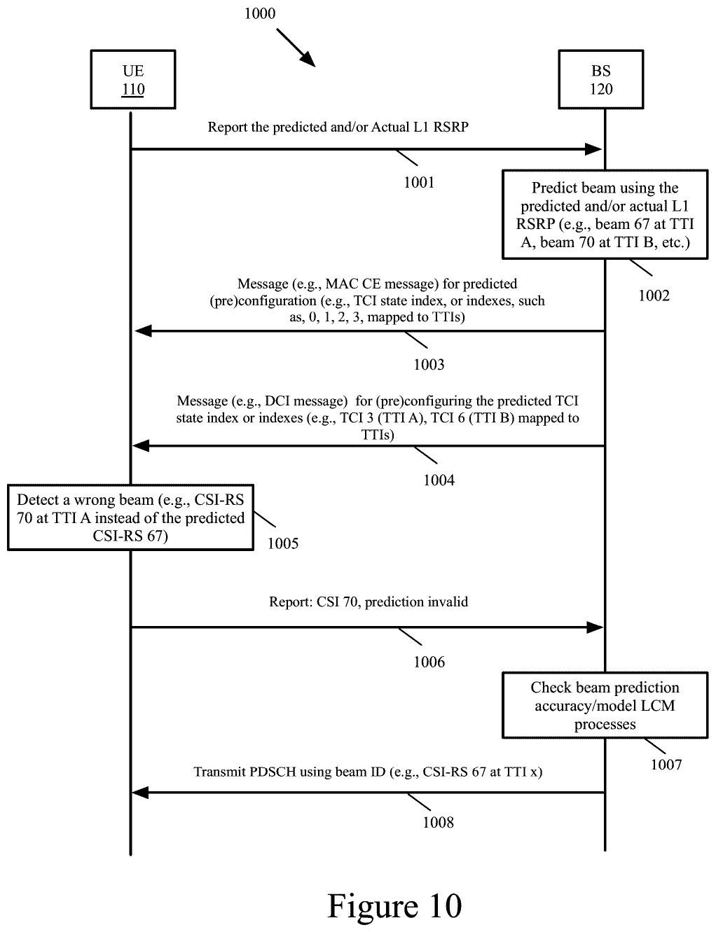

FIG. 10 is a sequence diagram 1000 illustrating an example message flow for detection and reporting a mismatch between a detected beam and a predicted beam, according to an example implementation of the present disclosure. In the example of FIG. 10, the steps (or blocks) 1001-1004 are similar to the corresponding steps (or blocks) 301-304 described above with reference to FIG. 3.

The network configures the UE with prediction configurations including predicted beam(s) information and the related TCI state indexes. This may include different options and combinations as discussed above with reference to tables 400, 500, 600, and 700. As shown in step 1005, the UE may determine that the detected beam (or a set of detected beams) do(es) not match the predicted beam provided in the prediction configuration. For example, the UE may detect the beam with CSI-RS 70 ID instead of predicted beam with the CSI-RS 67 ID.

After the UE identifies the mismatch, the UE may send a message to report (as shown in step 1006) the actual detected beam (or beam set) with the corresponding ID(s) and related information to the network. The message may include a failure message indicating that the prediction configuration is invalid or did not match the detected beam (or beam set). The prediction configuration failure and the beam set configuration information may be reported with the cause of failure. It should be noted that, in the present embodiments, a UE that has received beam management pre-configuration from the BS does not send a report to the BS when the detected beam matches the predicted beam. As such, in some embodiments, when the UE detects a beam that is different than the predicted beam, the UE may report the detected beam to the network without a failure indication. In this case, the network may implicitly imply, that the prediction was incorrect.

After receiving the failure notification, the network may feed (as shown in block 1007) the information to its AI/ML model life cycle management (LCM) processes to re-train the model and/or to assess the prediction accuracy of the applied AI/ML model for beam prediction configurations. The network may transmit (as shown in step 1008) the PDSCH using the detected beam's ID. The network may also provide the UE with a new beam configuration and a new prediction configuration for future applications. The UE and the network may also trigger beam failure recovery mechanisms.

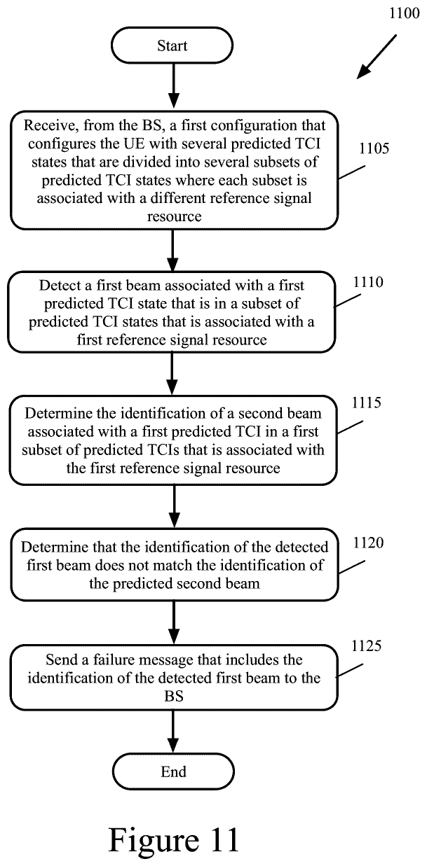

FIG. 11 is a flowchart illustrating an example method/process 1100 performed by a UE for detecting and reporting a mismatch between a detected beam and a predicted beam, according to an example implementation of the present disclosure. The process 1100 may be performed by at least one processor of the UE 110, shown in FIGS. 1 and 10.

The process 1100 may receive (at block 1105), from the BS, a first configuration that configures the UE with several predicted TCI states that are divided into several subsets of predicted TCI states where each subset is associated with a different reference signal resource. For example, the process 1100 may receive the configuration in a message, such as, MAC CE, DCI, RRC, etc.

The configuration may be received from the BS, for example, as described with reference to steps 1003-1004 in FIG. 10. As shown in FIG. 1, the UE 110 may receive a configuration that includes the predicted TCI states TCI 0 to TCI 11. The predicted TCI states TCI 0 to TCI 11 are divided into several subsets of predicted TCI states such as the subset that includes TCI 0 to TCI 3, the subset that includes TCI 4 to TCI 7, and the subset that includes TCI 8 to TCI 11. Each subset of predicted TCI states may be associated with a different reference signal resource. For example, the subset that includes TCI 0 to TCI 3 may be associated with SSB0, the subset that includes TCI 4 to TCI 7 may be associated with SSB1, and the subset that includes TCI 8 to TCI 11 may be associated with SSB2. Other types of channel reference resource to which the subsets of predicted TCI states may be associated are CSI-RS, SRS, and PTRS. Each subset of the predicted TCI states 131-133 may be associated to a wide beam 131-133, and each predicted TCI state TCI 0 to TCI 11 may be associated with a narrow beam 141-152.

Referring back to FIG. 11, the process 1100 may detect (at block 1110) a first beam associated with a first predicted TCI state in a first subset of predicted TCI states that is associated with a first reference signal resource. For example, the UE 110 in FIG. 1 may detect the beam 144 that is associated with the subset of predicted TCI states that includes TCI 0 to TCI 3, which is associated with SSB0.

The process 1100 may determine (at block 1115) the identification of a second beam associated with a first predicted TCI in a first subset of predicted TCIs that is associated with the first reference signal resource. For example, the process 1100 may identify the beam 141 that is associated with the first reference signal resource. It should be noted that the second beam is the predicted beam, and the first beam is the beam that the UE has actually detected.

The process 1100 may determine (at block 1120) that the identification of the detected first beam does not match the identification of the predicted second beam. For example, the UE may determine that the identification of the detected beam is CSI-RS 67 and the identification of the predicted beam is CSI-RS 64 do not match.

The process 1100 may send (at block 1125) a failure message that includes the identification of the detected first beam to the BS. For example, the UE 110 may send the failure notice as described above with reference to step 1006 of FIG. 10. The process 1100 may then end.

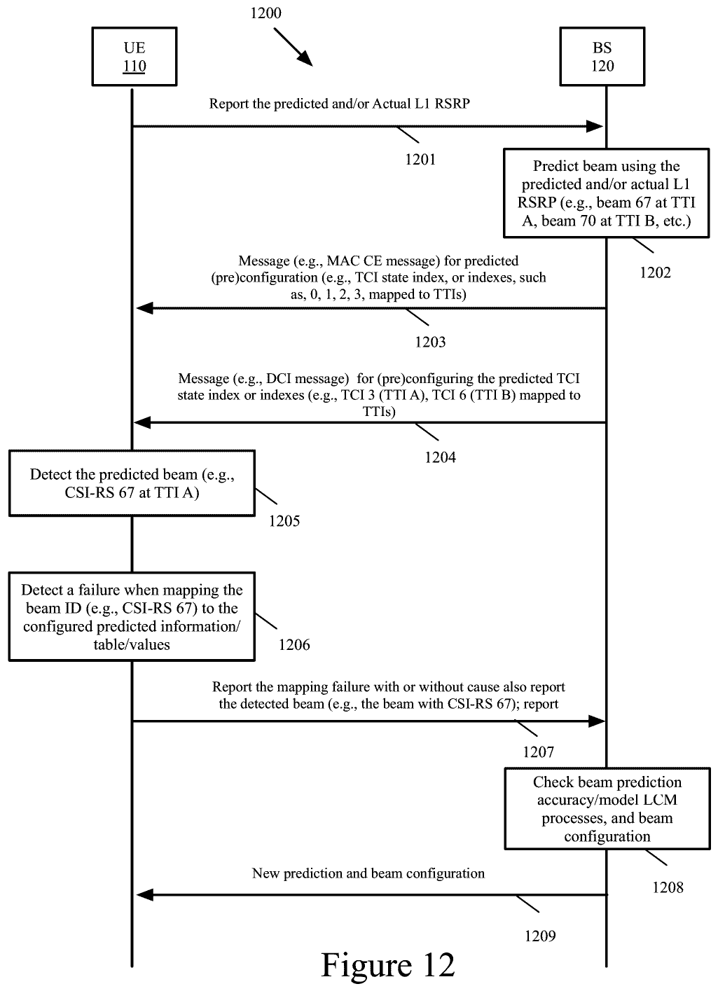

FIG. 12 is a sequence diagram 1200 illustrating an example message flow for detection and reporting a mapping failure after detecting a predicted map, according to an example implementation of the present disclosure. In the example of FIG. 12, the steps (or blocks) 1201-1204 are similar to the corresponding steps (or blocks) 301-304 described above with reference to FIG. 3.

The network configures the UE with prediction configurations including predicted beam(s) information and the related TCI state indexes. This includes different options and combinations as discussed above with reference to tables 400, 500, 600, and 700. As shown in step 1205, the UE may detect a predicted beam. For example, the UE may detect the beam with CSI-RS 67 ID which is the same as the ID of the predicted beam.

In step 1205, the UE 110 may detect the beam that was predicted by the configuration. In step 1206, the UE may detect a failure in mapping the detected or actual beam (or beam set) configuration with the AI/ML based predicted beam (pre) configuration provided by the network. This may be due to several reasons, for example, some parameters of the predicted configuration provided by the network may match while other parameters may not match with the actual detected beam/beam set configuration.

After the UE identifies mismatch, the UE may report (as shown in step 1207) the actual detected beam (or beam set) with the corresponding ID(s) and any related information to the network together with a failure message that indicates the mapping failure between prediction configuration and the actual detected beam or beam set configuration. The mapping failure and beam set configuration information maybe reported with the cause of failure.

After receiving the failure notification, the BS 120 may feed (as shown in block 1208) this information to its AI/ML model LCM processes to re-train the model and/or assess the prediction accuracy of the applied AI/ML model for beam prediction configurations. The BS 120 may also provide (as shown in block 1209) the UE 110 with a new beam configuration and/or a new beam prediction (pre) configuration for future applications. The UE and the network may also trigger beam failure recovery mechanisms.

In one embodiment, the network may also deactivate the predicted configured TCI states or indexes (e.g., the AI/ML based predicted beam (pre) configuration) based on the AI/ML prediction if the prediction accuracy is not up to a desired threshold.

In another embodiment, the UE may itself deactivate the predicted configured TCI states or indices (e.g., the AI/ML based predicted beam (pre) configuration) based on the AI/ML prediction if the prediction accuracy is not up to a desired threshold and may report it to the network with or without the cause/reason for deactivation.

Deactivation of predicted configured TCI states may occur in situations, for example, where certain TCI configurations are no longer needed or its obsolete or not accurate or where resource allocation priorities change.

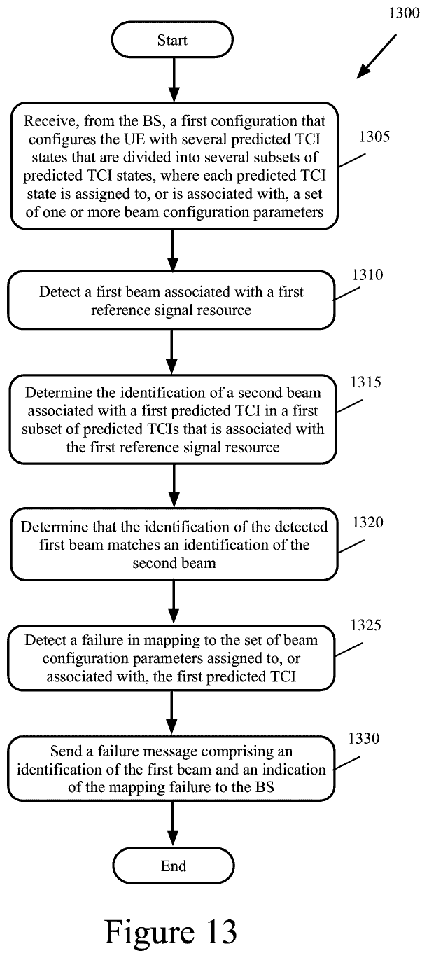

FIG. 13 is a flowchart illustrating an example method/process 1300 performed by a UE for detecting and reporting a mapping failure in one or more beam configuration parameters, according to an example implementation of the present disclosure. The process 1300 may be performed by at least one processor of the UE 110, shown in FIGS. 1 and 12.

The process 1300 may receive (at block 1105), from the BS, a first configuration that configures the UE with several predicted TCI states that are divided into several subsets of predicted TCI states, where each predicted TCI state is assigned to, or is associated with, a set of one or more beam configuration parameters. For example, the process 1100 may receive the configuration in a message, such as, MAC CE, DCI, RRC, etc. The beam configuration parameters may be, for example, the predicted beam identification (e.g., a logical beam ID for the predicted beam), the serving cell information, the beamforming weights, the beamwidth, the beam directionality, the beam polarization setting, the CRI, the reference signal index, the RSRP related information, and/or the beam codebook.

The configuration may be received from the BS, for example, as described with reference to steps 1203-1204 in FIG. 12. As shown in FIG. 1, the UE 110 may receive a configuration that includes the predicted TCI states (or TCI indexes) TCI 0 to TCI 11. The predicted TCI states TCI 0 to TCI 11 are divided into several subsets of predicted TCI states such as the subset that includes TCI 0 to TCI 3, the subset that includes TCI 4 to TCI 7, and the subset that includes TCI 8 to TCI 11. Each subset of predicted TCI states may be associated with a different reference signal resource. For example, the subset that includes TCI 0 to TCI 3 may be associated with SSB0, the subset that includes TCI 4 to TCI 7 may be associated with SSB1, and the subset that includes TCI 8 to TCI 11 may be associated with SSB2. Other types of channel reference resource to which the subsets of predicted TCI states may be associated are CSI-RS, SRS, and PTRS. Each subset of the predicted TCI states 131-133 may be associated to a wide beam 131-133, and each predicted TCI state TCI 0 to TCI 11 may be associated with a narrow beam 141-152.

Referring back to FIG. 13, the process 1300 may detect (at block 1310) a first beam associated with a first reference signal resource. For example, the UE 110 in FIG. 1 may detect the beam 144 that is associated with SSB0.

The process 1300 may determine (at block 1315) the identification of a second beam associated with a first predicted TCI in a first subset of predicted TCIs that is associated with the first reference signal resource. For example, the process 1300 may identify the beam 144 that is associated with the first reference signal resource.

The process 1300 may determine (at block 1320) that the identification of the detected first beam matches the identification of the predicted second beam. For example, the UE may determine that the identifications of both the detected beam and the predicted beam are CSI-RS 67.

The process 1300 may detect (at block 1325) a failure in mapping to the set of beam configuration parameters assigned to, or associated with, the first predicted TCI. For example, the process 1300 may detect a mapping failure as described above with reference to step 1206 of FIG. 12.

The failure in mapping may happen when at least one beam configuration parameter in the set of beam configuration parameters associated with the first predicted TCI does not match with a corresponding beam configuration parameter associated with the detected first beam. The failure in mapping may also happen when the UE is unable to map to the set of beam configuration parameters associated with the first predicted TCI. The failure in mapping may further happen when the UE takes more than a threshold amount of time to map to the set of beam configuration parameters associated with the first predicted TCI or the UE moves to a random location.

The process 1300 may send (at block 1330) a failure message comprising an identification of the first beam and an indication of the mapping failure to the BS. For example, the process 1300 may send a failure message to the BS as described above with reference to step 1207 of FIG. 12. The process 1300 may then end.

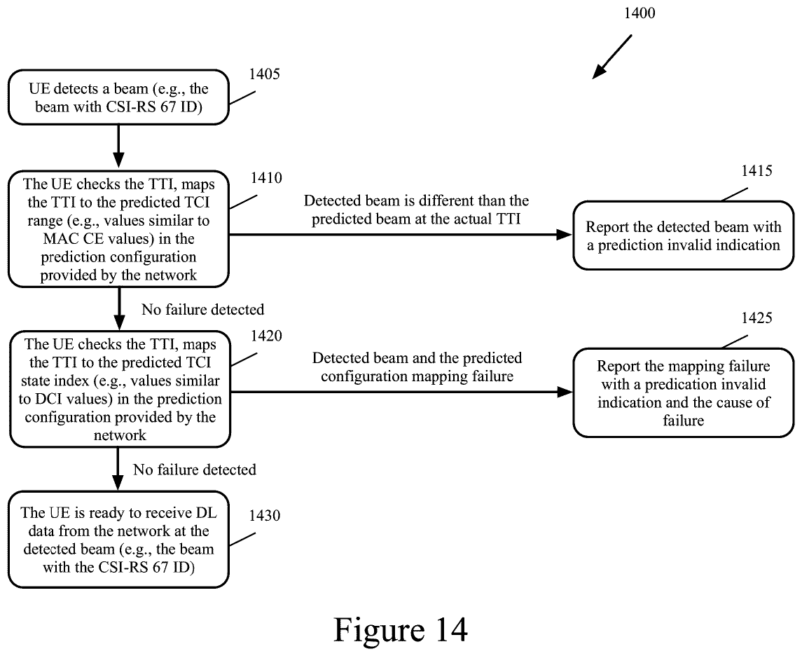

FIG. 14 is a flowchart illustrating an example process 1400 that describes the UE's behavior, including failure detection and reporting, after receiving the beam prediction configuration and beam configuration/management information from the network, according to an example implementation of the present disclosure. The process 1400 may by at least one processor of the UE 110, shown in FIGS. 1, 3, 10, and 12.

The process 1400 may UE detect (at block 1405) a beam (e.g., the beam with CSI-RS 67 ID). for example, the UE 110 may detect a beam as described above with reference to step 1005 of FIG. 10 or the step 1205 of FIG. 12.

The process 1400 may check (at block 1410) the TTI and may map the TTI to the predicted TCI range (e.g., values similar to MAC CE values) in the prediction configuration provided by the network. In a case that the process determines that the detected beam is different than the predicted beam at the actual TTI, the process 1400 may report (at block 1415) the detected beam with a prediction invalid indication. For example, the process 1400 may report the failure as described above with reference to step 1006 of FIG. 10.

Otherwise, the process 1400 may check (at block 1420) the TTI and may map the TTI to the predicted TCI state index (e.g., values similar to DCI values) in the prediction configuration provided by the network. In a case that the process determines that there is a failure in mapping the detected beam and the predicted configuration, the process 1400 may report (at block 1425) the mapping failure with a predication invalid indication and the cause of failure. For example, the process 1400 may report the failure as described above with reference to step 1207 of FIG. 12.

Otherwise, the process 1400 may be ready to receive DL data from the network at the detected beam (e.g., the beam with the CSI-RS 67 ID using the assigned TCI state index). For example, the process 1400 may receive the DL data as described above with reference to step 309 of FIG. 3.

In should be noted that in any of the above-mentioned processes, the message exchange between the network and the UE maybe implemented using for example, PHY/MAC/RRC messages, an L1/L2/L3 message, a new type of message, and/or a higher layer message.

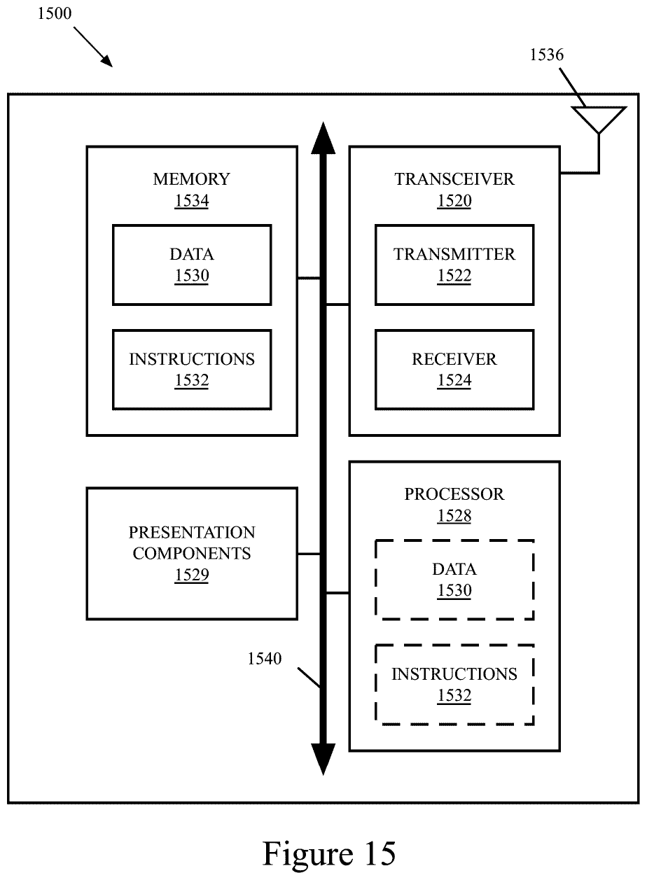

FIG. 15 is a block diagram illustrating a node 1500 for wireless communication, according to an example implementation of the present disclosure. As illustrated in FIG. 15, a node 1500 may include a transceiver 1520, a processor 1528, a memory 1534, one or more presentation components 1529, and at least one antenna 1536. The node 1500 may also include a radio frequency (RF) spectrum band module, a BS communications module, a network communications module, and a system communications management module, Input/Output (I/O) ports, I/O components, and a power supply (not illustrated in FIG. 15).

Each of the components may directly or indirectly communicate with each other over one or more buses 1540. The node 1500 may be a UE or a BS that performs various functions disclosed with reference to FIGS. 1 through 14.

The transceiver 1520 has a transmitter 1522 (e.g., transmitting/transmission circuitry) and a receiver 1524 (e.g., receiving/reception circuitry) and may be configured to transmit and/or receive time and/or frequency resource partitioning information. The transceiver 1520 may be configured to transmit in different types of subframes and slots including, but not limited to, usable, non-usable, and flexibly usable subframes and slot formats. The transceiver 1520 may be configured to receive data and control channels.

The node 1500 may include a variety of computer-readable media. Computer-readable media may be any available media that may be accessed by the node 1500 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1534 may include computer-storage media in the form of volatile and/or non-volatile memory. The memory 1534 may be removable, non-removable, or a combination thereof. Example memory may include solid-state memory, hard drives, optical-disc drives, etc. As illustrated in FIG. 15, the memory 1534 may store a computer-readable and/or computer-executable instructions 1532 (e.g., software codes) that are configured to, when executed, cause the processor 1528 to perform various functions disclosed herein, for example, with reference to FIGS. 1 through 3. Alternatively, the instructions 1532 may not be directly executable by the processor 1528 but may be configured to cause the node 1500 (e.g., when compiled and executed) to perform various functions disclosed herein.

The processor 1528 (e.g., having processing circuitry) may include an intelligent hardware device, e.g., a Central Processing Unit (CPU), a microcontroller, an ASIC, etc. The processor 1528 may include memory. The processor 1528 may process the data 1530 and the instructions 1532 received from the memory 1534, and information transmitted and received via the transceiver 1520, the baseband communications module, and/or the network communications module. The processor 1528 may also process information to send to the transceiver 1520 for transmission via the antenna 1536 to the network communications module for transmission to a CN.

One or more presentation components 1529 may present data indications to a person or another device. Examples of presentation components 1529 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment can also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions for reporting failures in predictive beam configurations received from a base station (BS); and
at least one processor coupled to the one or more non-transitory computer-readable media, and configured to execute the one or more computer-executable instructions to cause the UE to:
receive, from the BS, a first configuration that configures the UE with a plurality of predicted transmission configuration indication (TCI) states divided into a plurality of subsets of predicted TCI states, each subset associated with a different reference signal resources;
detect a first beam associated with a first reference signal resource;
determine an identification of a second predicted beam associated with a first predicted TCI state in a first subset of predicted TCI states that is associated with the first reference signal resource;
determine that an identification of the detected first beam does not match the identification of the second predicted beam; and
send a failure message indicating to the BS that the first configuration is invalid.

2. The UE of claim 1, wherein the failure message comprises information of the detected first beam as a cause of failure.

3. The UE of claim 2, wherein the information comprises a set of layer 1 reference signal reception power (L1-RSRP) measurements.

4. The UE of claim 2, wherein:
the information is for use by the BS to generate a second configuration,
the at least one processor is further configured to execute the one or more computer-executable instructions to cause the UE to:
receive, from the BS, the second configuration that configures the UE with at least one TCI state that is not in the plurality of TCI states.

5. The UE of claim 1, wherein the failure message comprises information of the predicted second beam as a cause of failure.

6. The UE of claim 1, wherein the at least one processor is further configured to execute the one or more computer-executable instructions to cause the UE to:
perform a set of one or more beam failure recovery procedures with the BS.

7. A user equipment (UE), comprising:
one or more non-transitory computer-readable media storing one or more computer-executable instructions for reporting failures in predictive beam configurations received from a base station (BS); and
at least one processor coupled to the one or more non-transitory computer-readable media, and configured to execute the one or more computer-executable instructions to cause the UE to:
receive, from the BS, a first configuration that configures the UE with a plurality of predicted transmission configuration indication (TCI) states divided into a plurality of subsets of predicted TCI states, each subset associated with a different reference signal resource, each predicted TCI state associated with a set of one or more beam configuration parameters;
detect a first beam associated with a first reference signal resource;
determine an identification of a second predicted beam associated with a first predicted TCI state in a first subset of predicted TCI states that is associated with the first reference signal resource;
detect a failure in a mapping to the set of beam configuration parameters associated with the first predicted TCI state; and
send a failure message indicating to the BS that the first configuration is invalid.

8. The UE of claim 7, wherein detecting the failure in the mapping comprises determining that at least one beam configuration parameter in the set of beam configuration parameters associated with the first predicted TCI state does not match with a corresponding beam configuration parameter associated with the detected first beam.

9. The UE of claim 7, wherein detecting the failure in the mapping comprises determining that the UE is unable to map to the set of beam configuration parameters associated with the first predicted TCI state.

10. The UE of claim 7, wherein detecting the failure in the mapping comprises determining that the UE takes more than a threshold amount of time to map to the set of beam configuration parameters associated with the first predicted TCI state.

11. The UE of claim 7, wherein:
the failure message is for use by the BS to generate a second configuration,
the at least one processor is further configured to execute the one or more computer-executable instructions to cause the UE to:
receive, from the BS, the second configuration that configures the UE with at least one TCI state that is not in the plurality of TCI states.

12. The UE of claim 7, wherein the one or more beam configuration parameters comprises one or more of a predicted beam identification, serving cell information, beamforming weights, a beamwidth, beam directionality, a beam polarization setting, a channel resource index (CRI), reference signal reception power (RSRP) related information, and a beam codebook.

13. The UE of claim 7, wherein the at least one processor is further configured to execute the one or more computer-executable instructions to cause the UE to:
receive a message from the BS deactivating a use of the first configuration by the UE to identify beams.

14. The UE of claim 7, wherein the at least one processor is further configured to execute the one or more computer-executable instructions to cause the UE to:
determine an accuracy of beam prediction is below a threshold;
deactivate a use of the first configuration to identify beams; and
send a message to the BS indicating the use of the first configuration is deactivated by the UE.

15. A method of reporting failures in predictive beam configurations received from a base station (BS), the method comprising:
receiving, from the BS, a first configuration that configures the UE with a plurality of predicted transmission configuration indication (TCI) states divided into a plurality of subsets of predicted TCI states, each subset associated with a different reference signal resources;
detecting a first beam associated with a first reference signal resource;
determining an identification of a second predicted beam associated with a first predicted TCI state in a first subset of predicted TCI states that is associated with the first reference signal resource;
determining that an identification of the detected first beam does not match the identification of the second predicted beam; and
sending a failure message indicating to the BS that the first configuration is invalid.
